(19) United States
(12) Patent Application Publication
(10) Pub. No.: US 2025/0174151 A1
(43) Pub. Date: May 29, 2025

(54) Tactical Training Tool

(71) Applicant: Zane Maltsberger, San Marcos, CA (US)

(72) Inventor: Zane Maltsberger, San Marcos, CA (US)

(21) Appl. No.: 19/038,009

(22) Filed: Jan. 27, 2025

Related U.S. Application Data
(63) Continuation-in-part of application No. 29/889,498, filed on Apr. 13, 2023, now Pat. No. D062984.

(51) Int. Cl. G09B 19/00; F21L 4/00; F21V 23/04; F21V 23/06; F21Y 115/10

(52) U.S. Cl. CPC G09B 19/0007; F21V 23/0421; F21V 23/06; F21L 4/00; F21Y 2115/10

(57) ABSTRACT

A tactical training device simulates disposable chemical light sticks (ChemLights) used in military and first responder operations. The device comprises a durable, reusable body with a hexagonal cross-section, dimensionally similar to standard ChemLights. A quick release clip attached to one end facilitates easy attachment to and removal from carrying cords. The device may be color-coded and customized with printed information. An alternative embodiment includes an internal LED system activated by removing the device from a carrying cord, providing a light-up feature. The invention enables cost-effective, environmentally friendly tactical training in various scenarios, including room clearing, perimeter marking, signaling, and low-light navigation. Methods of use and construction are also disclosed. The device offers a realistic, reusable alternative to disposable ChemLights for training purposes, reducing costs and environmental impact while maintaining exercise authenticity.

### CROSS-REFERENCE TO RELATED APPLICATIONS

This specification is a continuation in part of U.S. Des. Pat. App. Ser. No. 20/889,498 (filed Apr. 13, 2023) for a Tactical Training Tool. See also Application Data Sheet (ADS). The prior application and its file history are hereby incorporated by reference in their entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

One embodiment of the present disclosure was disclosed via an Instagram® post by Tacstix LLC dated Sep. 19, 2022 under the handle “tacstix.” The content of that post is a photo depicting a handful of the claimed Tactical Training Tools coupled to a tactical vest set on a chair with a caption that says, among other things, “Day One testing.” At the time, Inventor Zane Maltsberger was principle member or owner of Tacstix LLC and: (1) controlled the content of that account; (2) caused production of the Tactical Training Tools shown in identified Instagram® post; and (3) personally participated in publishing the identified Instagram® post on the tacstix handle.

### BACKGROUND OF THE INVENTION

### Field of Invention

The present subject matter relates generally to the field of tactical training equipment, and more specifically to reusable training devices that simulate disposable chemical light sticks (ChemLights) used in military and first responder operations.

### Listing of Relevant Art

Cyalume® brand, military grade ChemLights, including the Cyalume-9-03680 ChemLight are used for tactical applications, to illuminate small spaces, or as part as an emergency kit. These ChemLights are said to be the “Official Chemical Light of the U.S. Military” and “standard issue for all military personnel.”

U.S. Pat. No. 309669 by Wheatley (issued Dec. 23, 1884) discloses a clothes pin.

U.S. Pat. No. 613174 by Rice (issued Oct. 25, 1898) discloses a clothes pin attachment.

U.S. Pat. No. 1,065,047 by Hofstad (issued Jun. 17, 1913) discloses a wire clothes pin.

U.S. Pat. No. 1,499,292 by Clause (issued Jun. 24, 1924) discloses an attachment for clothespin.

U.S. Pat. No. 3,576,987 by Ridgefield et al (issued May 4, 1971) discloses a “Chemical Lighting Device to Store, Initiate, and Display Chemical Light.”

U.S. Pat. No. 3,819,925 by Richter et al. (issued Jun. 25, 1974) discloses a chemiluminescent device.”

U.S. Pat. No. 3,899,254 by Dixon et al (issued Aug. 12, 1975) discloses a chemical light meter and method of measuring light therewith.

U.S. Pat. No. 4,104,708 by Bohli (issued Aug. 1, 1978) discloses a shrouded chemical light source.

U.S. Pat. No. 4,179,204 by Robinson (issued Dec. 18, 1979) discloses a method and apparatus for photographing chemiluminescent objects.

U.S. Pat. No. 5,043,851 by Kaplan (issued Aug. 27, 1991) discloses a polygonal chemiluminescent lighting device.

5067051 by Ladyjensky (issued Nov. 19, 1991) discloses a chemiluminescent lighting element.

U.S. Pat. No. 5,430,622 by Kuo (issued Jul. 4, 1995) discloses a light emitting torch.

U.S. Pat. No. 5,400,008 by Toohey (issued Mar. 21, 1995) discloses a location marker.

U.S. Pat. No. 5,673,988 by Fujita (issued Oct. 7, 1997) discloses a chemical luminescence apparatus.

U.S. Pat. No. 6,217,187 by Demsko (issued Apr. 17, 2001) discloses a baton for displaying and storing light sticks.

U.S. Pat. No. 6,213,623 by Campman (issued Apr. 10, 2001) discloses a glow and flash baton.

U.S. Pat. No. 6,364,499 by Jones (issued Apr. 2, 2002) discloses an apparatus for illuminating an archer's arrow. The abstract reads:
An apparatus for illuminating an archer's arrow that provides a nock adapted to receive a bowstring in a drawn position wherein a light source disposed withing the nock is activated when the bowstring is released from the drawn position. The nock provides a slot which is adapted to receive the bowstring. The slot provides a first widening portion adapted to receive the bowstring in a drawn position, and a second widening portion adapted to receive the bowstring when the bowstring is released from the drawn position. The nock also provides a bore which intersects at least a portion of the second widening portion of the slot. The light source is preferably a chemi-luminescent light stick which fits snugly within the bore of the nock. The bowstring engages and activates the light stick when the bowstring is released from the drawn position

U.S. Pat. No. 7,931,550 by Lynch (issued Apr. 26, 2011) discloses a “programmable lighted archery nock.”

U.S. Pat. No. 6,478,439 by Rockwell (issued Nov. 12, 2002) discloses an apparatus for attaching chemiluminescent device to a fishing line. The abstract reads:
A mechanism for attaching a light stick to a filament, includes opposing elements having proximal ends attached to the light stick and distal ends. A gap is formed between the elements. Near the distal end the gap is tapered to form a funnel portion wider than the filament. Near the proximal end the gap forms a gripping portion narrower than the filament.

U.S. Pat. No. 6,619,808 by Pelto (issued Sep. 16, 2003) discloses a chemiluminescent device having a multicolored casing and method therefor.

U.S. Pat. No. 6,685,331 by Rockwell (issued Feb. 3, 2004) discloses a chemiluminescent device.

U.S. Pat. No. 7,682,033 by Cranor (assigned to Cyalume Tech. Inc. and issued Mar. 3, 2010) discloses a polygonal chemiluminescent lighting device.

U.S. Pat. No. 8,444,291 by Swan et al. (issued May 21, 2013) discloses an LED illuminating device for use during tactical operations, and method.

U.S. Pat. No. 8,974,068 by Theissen (issued Mar. 10, 2015) discloses a chemiluminescent light stick with zip tie attachment.

U.S. Pat. No. 9,714,742 by Jackson (issued Jul. 25, 2017) discloses a light source carrier.

U.S. patent Ser. No. 10/830,395 by Jackson (issued Nov. 10, 2020) discloses a chemiluminescent light source.

U.S. patent Ser. No. 11/572,983 by Jackson (Feb. 7, 2023) discloses an illuminated carrier.

U.S. Pub. Pat. App. No. 20050007760 by Wu (published Jan. 13, 2001) discloses a multicolor chemiluminescent light device.

U.S. Pub. Pat. App. No. 20080291658 by Cranor (published Mar. 23, 2003) discloses a polygonal chemiluminescent lighting device.

U.S. Pub. Pat. App. No. 20090175024 by Cranor et al (published Jun. 1, 2010) discloses a chemiluminescent tactical illumination baton.

U.S. Pub. Pat. App. No. 20100014275 by Cranor (published Jan. 21, 2010) discloses an end cap attachment for chemiluminescent light sticks.

U.S. Pub. Pat. App. No. 20170087920 by Guo (published Nov. 6, 2018) discloses a device for dispensing chemiluminescent solution.

U.S. Pat. No. D274317 by Neslon (issued Jun. 19, 1984) discloses a self-powered illuminated signal.

U.S. Pat. No. D300602 by Smith, Sr. (issued Apr. 11, 1989) discloses a combined handle and holder for chemiluminescent signal.

U.S. Pat. No. D331889 by Kaplan (issued Dec. 22, 1992) discloses a chemiluminescent light stick.

U.S. Pat. No. D338387 by Smith, Sr. (issued Aug. 17, 1993) discloses a combined handle and holder for chemiluminescent signal.

U.S. Pat. No. D356276 by Keyko (issued Mar. 14, 1995) discloses an illumination torch.

U.S. Pat. No. D357882 by Wilson et al. (issued May 2, 1995) discloses a chemiluminescent light stick.

U.S. Pat. No. D363037 by Wilson et al. (issued Oct. 10, 1995) discloses a chemiluminescent light stick.

U.S. Pat. No. D368045 by Akers, Sr. (issued Mar. 19, 1996) discloses a chemiluminescent light stick.

U.S. Pat. No. D391653 by Ford et al (issued Mar. 3, 1998) discloses a light stick.

U.S. Pat. No. D452926 by Wu (issued Jan. 8, 2001) discloses a light stick.

U.S. Pat. No. D458339 by Cheong (issued Jun. 4, 2002) discloses a fishing light.

U.S. Pat. No. D503005 by Jujita (issued Mar. 15, 2005) discloses a chemiluminescent device.

U.S. Pat. No. D528237 by Ford (issued Sep. 12, 2006) discloses a light stick.

U.S. Pat. No. D574979 by Ford (issued Aug. 12, 200) discloses a light stick.

U.S. Pat. No. D598150 by Bertken (issued Aug. 11, 2009) discloses a combined glow stick and multi-purpose safety device.

U.S. Pat. No. D625860 by Bertken (issued Oct. 19, 2010) discloses a glow stick.

U.S. Pat. No. D625861 by Bertken (issued Oct. 19, 2010) discloses a glow stick.

U.S. Pat. No. D626671 by Bertken (issued Nov. 2, 2010) discloses a glow stick multi-purpose safety light.

U.S. Pat. No. D648466 by Hickman (issued Nov. 8, 2011) discloses a hexagonal glow light.

U.S. Pat. No. D651333 by Schrimmer (issued Dec. 27, 2011) disclose a light stick.

U.S. Pat. No. D655026 by Schrimmer (issued Feb. 28, 2012) discloses a light stick.

U.S. Pat. No. D705866 by Adelman (issued May 27, 2015) discloses a pen holder including a stylus.

U.S. Pat. No. D743074 by Hwang (issued Nov. 10, 2015) discloses a glow stick with whistle.

U.S. Pat. No. D793595 by Lesperance (issued Aug. 1, 2017) discloses a glow stick.

U.S. Pat. No. D875286 by Shi et al (issued Feb. 11, 2020) discloses a fishing light.

U.S. Pat. No. D945032 by Qiu (issued Mar. 1, 2022) discloses a glow stick.

U.S. Pat. No. D997007 by Costle et al. (issued Aug. 29, 2023) discloses a safety glow stick triangle.

See also the Information Disclosure Statements (IDS) of record.

### Background of the Invention

Cyalume® brand ChemLights, including the Cyalume-9-03680 model, have become the standard for tactical illumination in military and first responder operations. These “Official Chemical Light of the U.S. Military” are widely used for various tactical applications, including perimeter marking, signaling, room clearing, hazard identification, and emergency lighting. See IDS of record. The versatility and reliability of these glow sticks make them invaluable tools in high-stakes scenarios.

The widespread use of these disposable ChemLights in training exercises presents significant challenges. Each ChemLight has a cost that makes the use of ChemLights in training scenarios expensive. Moreover, the single-use nature of these chemical light sticks results in considerable waste, raising environmental or sustainability concerns and increasing long-term costs for training programs.

Given these issues, there exists a clear need for a reusable alternative that can simulate the functionality of ChemLights in training environments. Such a solution would need to replicate the physical characteristics and tactical utility of standard glow sticks while offering the benefits of reusability and cost-effectiveness.

### SUMMARY OF THE INVENTION

The present subject matter is a tactical training tool, known as TACSTIX. TACSTIX addresses the aforementioned need by providing a reusable plastic stick designed for tactical training. TACSTIX closely mimics the dimensions and weight of operational ChemLights, allowing for realistic training scenarios without the associated costs and waste of disposable glow sticks.

Key features of the TACSTIX include, but are not limited to, the following. First, Reusable Construction: Made from durable plastic, allowing for repeated use in training exercises. Second, Hexagonal Cross-Section: This unique shape reduces rolling when the stick is thrown or dropped, ensuring it stays where placed. Third, Quick Release Clip or Knock: Facilitates easy attachment to and removal from a carrying cable, simulating real-world tactical gear management. Fourth, Dimensional Accuracy: Matches the size and weight of standard operational ChemLights for authentic handling and deployment. Fifth, Customizable Exterior: Allows for printing of advertisements, names, or contact information on the sides of each unit. Finally, Color Coding: Available in various colors to simulate different tactical signals or markers.

In an alternative embodiment, TACSTIX incorporates a “light up” feature. This version includes a battery and LED system with a trigger within the quick release clip or knock that activates when a carrying cord or other holder stick is removed from the clip or knock and deactivates when reattached to the carrying cord or other holder, further enhancing training realism.

The TACSTIX system enables a variety of training methods, including:
Room Clearing Exercises-Trainees can use TACSTIX to mark cleared rooms, simulating real-world tactics without expending actual ChemLights;
Perimeter Marking Drills-Practice setting up secure areas or danger zones using reusable markers;
Signaling Practice-Utilize different colored TACSTIX to rehearse various signaling protocols;
Low-Light Navigation Training-Employ the “light up” version to simulate glow stick use in dark environments;
Equipment Management Training-Train personnel on proper handling and deployment of tactical markers without the pressure of wasting resources;
Parachute Operations Training-Train personnel on using illumination devices on helmets for night jumps;
MOLLE system familiarization: Train users on transferring the illuminating device between helmet and MOLLE gear;
Tactical gear transition drills: Practice moving the illuminating device from helmet to ground operations equipment.
Snag hazard awareness: Train users on proper placement of the device to minimize snagging risks during parachute deployment; and,
Multi-color signaling drills: Practice using different illumination colors for various tactical scenarios.

TACSTIX fills a crucial gap in tactical preparedness programs. It allows for more frequent and realistic training scenarios by providing a cost-effective, environmentally friendly alternative to disposable ChemLights for training purposes. TACSTIX ultimately enhances the readiness and effectiveness of military and first responder teams.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1 is a perspective view of a tactical training tool;

FIG. 2 is a front view of the tactical training tool of FIG. 1;

FIG. 3 is a back view of the tactical training tool of FIG. 1;

FIG. 4 is a right side view of the tactical training tool of FIG. 1;

FIG. 5 is a left side view of the tactical training tool of FIG. 1;

FIG. 6 is a top view of the tactical training tool of FIG. 1;

FIG. 7 is a bottom view of the tactical training tool of FIG. 1;

FIG. 8 is a perspective view of a tactical training tool;

FIG. 9 is a front view of the tactical training tool of FIG. 9;

FIG. 10 is a back view of the tactical training tool of FIG. 8;

FIG. 11 is a right side view of the tactical training tool of FIG. 8;

FIG. 12 is a left side view of the tactical training tool of FIG. 8;

FIG. 13 is a top view of the tactical training tool of FIG. 8;

FIG. 14 is a bottom view of the tactical training tool of FIG. 8;

FIG. 15 is a see-through, right side view of the tactical training tool of FIG. 8 with a carrying ring decoupled from the knock of the tactical training tool;

FIG. 16 is see-through left-side view of the tactical training tool of FIG. 8 with a carrying ring decoupled from the knock of the tactical training tool;

FIG. 17 is a see through, right side view of the tactical training tool of FIG. 8 with a carrying ring coupled thereto via knock of the tactical training tool;

FIG. 18 is a see through, perspective side view of the tactical training tool of FIG. 8 with a carrying ring coupled thereto via knock of the tactical training tool; and,

FIG. 19 is another see through, perspective view of the tactical training tool of FIG. 8 with a carrying ring coupled thereto via knock of the tactical training tool.

In the figures, the following components of the preferred embodiment are shown in connection with the corresponding reference numeral identified below:

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

This is a specification of a TACSTIX. In general, the TACSTIX is defined by a reusable plastic stick for tactical room clearing. For instance, the stick may be color coded and thrown in a room to indicate a room has been checked for occupancy (e.g., by a team of Navy Seals). In a preferred embodiment, the stick is hexagonal in cross-section for less rolling and includes a quick release clip for carrying on a cable. Suitably, the item would feature similar dimensions to operational chem lights (glow sticks), including similar weight to operational chem lights. Suitably, an advertisement, name, or contact info could be printed on sides of each unit.

The present invention provides a tactical training tool, referred to as TACSTIX, which is a reusable plastic stick designed to simulate disposable chemical light sticks (ChemLights) used in military and first responder operations. The TACSTIX is particularly useful for tactical room clearing exercises and other training scenarios where ChemLights are typically employed.

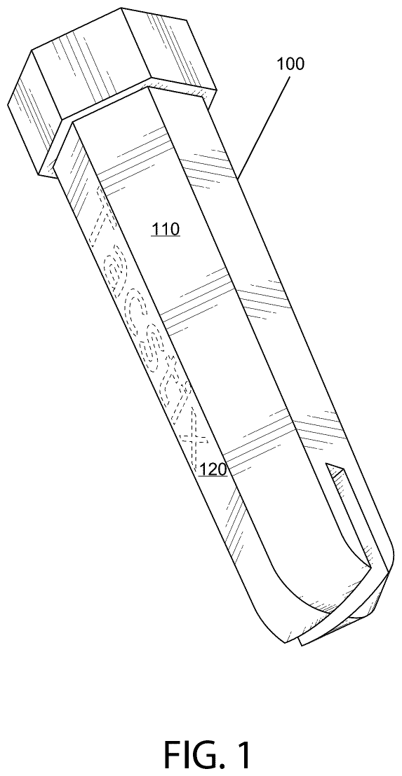

Referring to FIG. 1, a perspective view of the TACSTIX 100 is shown. The TACSTIX 100 comprises an elongated body 110 with a hexagonal cross-section. This hexagonal shape is a functional feature of the invention, as it prevents the TACSTIX from rolling when thrown or dropped, ensuring it remains in place during training exercises.

The TACSTIX 100 is preferably constructed from a durable plastic material that can withstand repeated use in training environments. The material should be chosen to closely match the weight of standard ChemLights, providing trainees with an authentic handling experience.

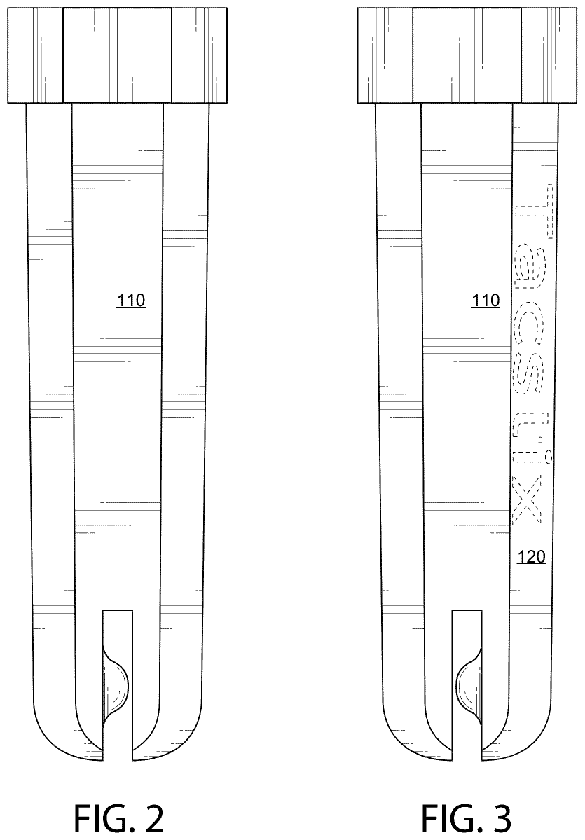

As shown in FIGS. 2 and 3, the front and back views of the TACSTIX 100 reveal flat surfaces 120 suitable for customization. These surfaces can be used to print advertisements, names, contact information, or other relevant details, enhancing the versatility of the tool for different training scenarios or organizational needs.

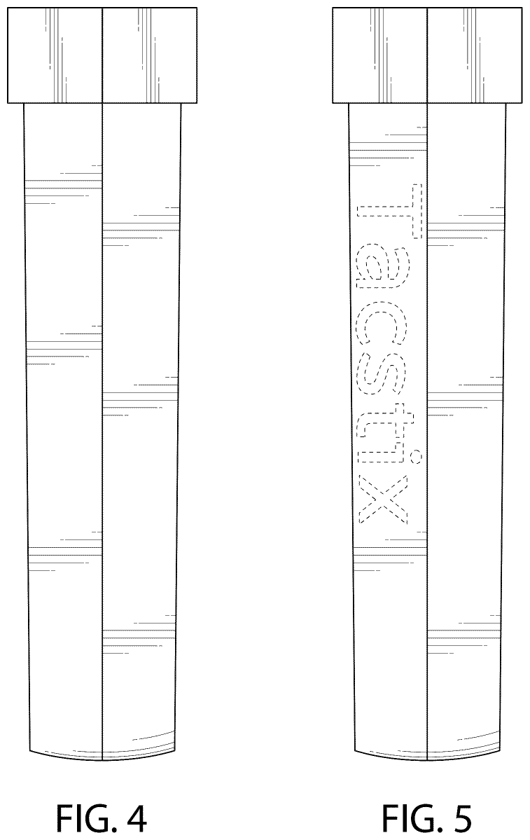

FIGS. 4 and 5 depict the right and left side views of the TACSTIX 100, respectively. These views highlight the hexagonal profile of the body 110, which is consistent along the entire length of the device. The front or top end is rounded on four of the flat surfaces 110 to form hexagonal bulb.

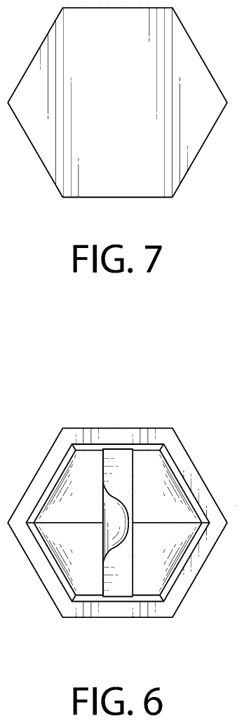

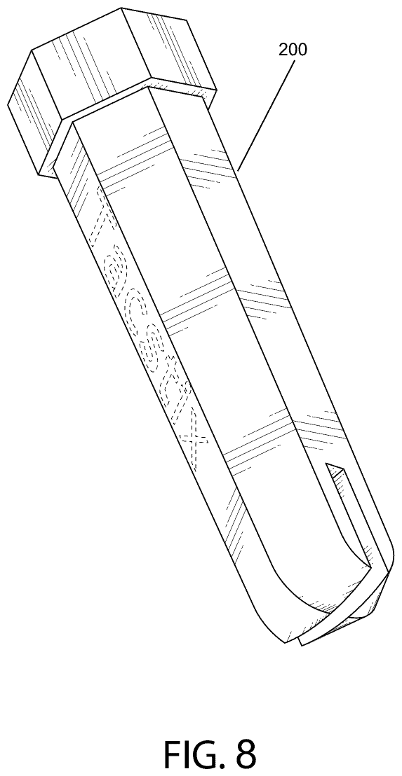

FIGS. 6 and 7 show the top and bottom of the TACSTIX 100. Referring to FIG. 6, the top view of the TACSTIX 100 shows a quick release clip 130 integrated into the upper end of the body 110. This clip 130 is designed to facilitate easy attachment to and removal from a carrying cable, simulating the management of tactical gear in real-world scenarios. As shown, the clip is defined by two prongs with a nock and a bump 131 for retaining the TACSTIX 100 on a string or other holder (e.g., a ring 500 (not shown in FIGS. 1 through 7 but discussed below). FIG. 7 illustrates the bottom view of the TACSTIX 100, which maintains the hexagonal profile and may include additional features such as a textured surface for improved grip.

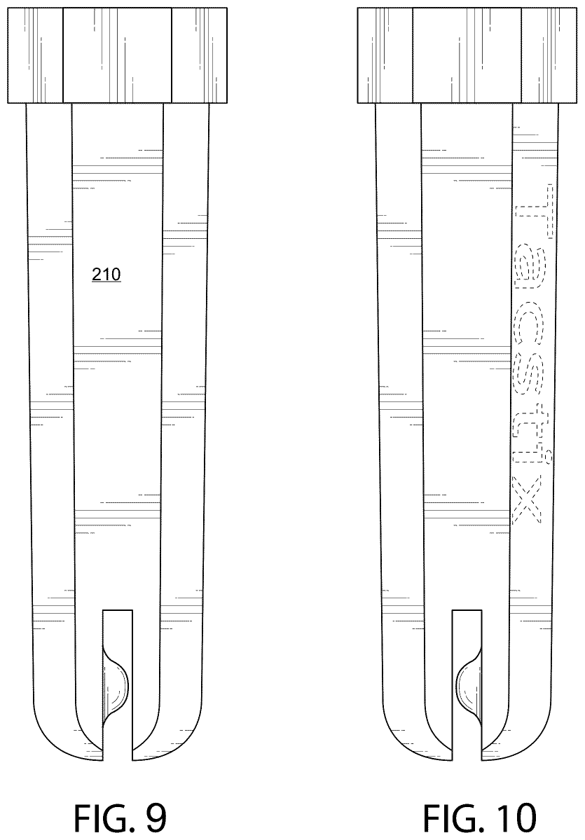

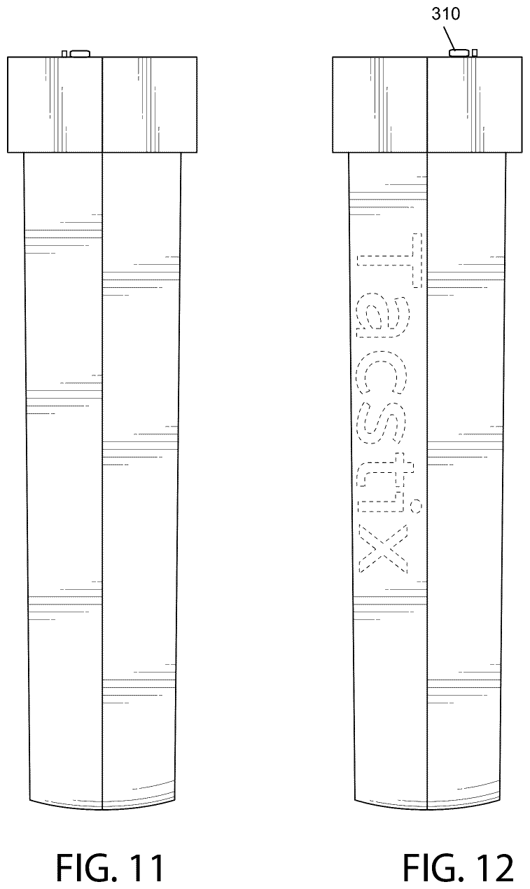

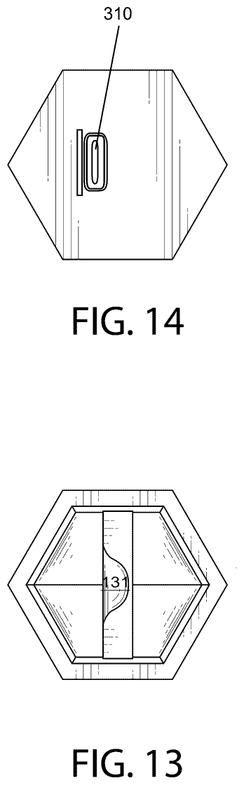

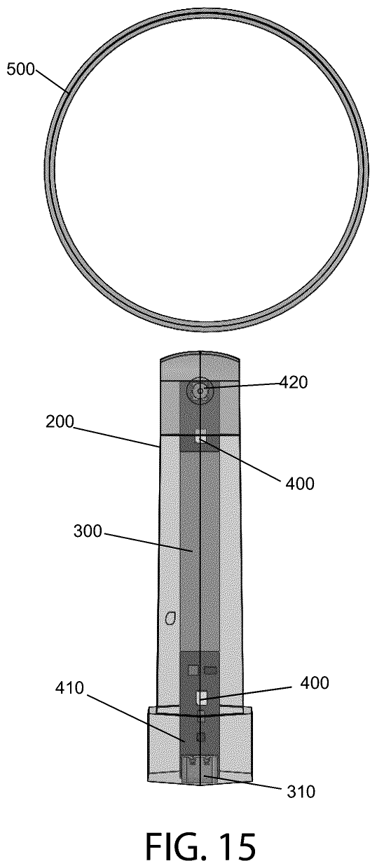

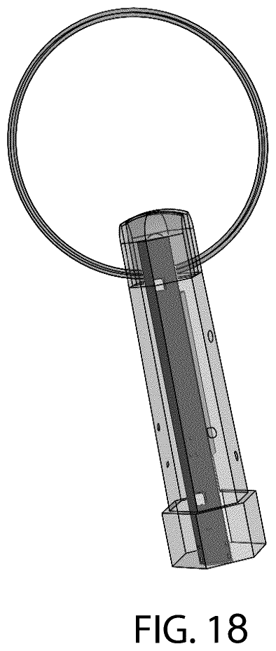

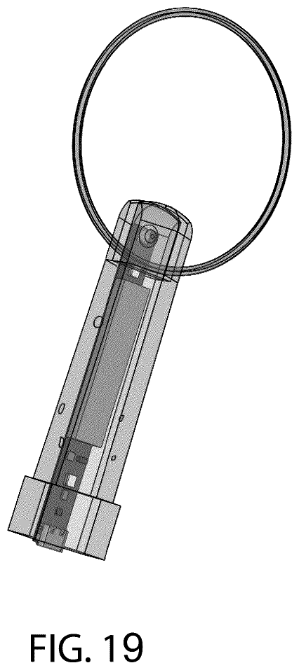

FIGS. 8 through 14 show respectively perspective, front, back, right, left, top and bottom views of an alternate embodiment of the TACSTIX 200. FIGS. 15 through 19 show various see-through views of the alternate embodiment of the TACSTIX 200. In this alternative embodiment, the TACSTIX 200 may has all the features of the earlier embodiment 1000 (e.g., a body 210, a customizable flat surface 220, and a quick release clip 230). The difference between the earlier embodiment 100 and the alternative embodiment of the TACSTIX 200 is that the alternative embodiment 200 incorporates a “light up” feature.

To serve the light up feature, this version of the TACSTIX 200 includes a battery compartment (shown in FIGS. 15 through 19) with a battery 300 housed within the body 210, one or more Light Emitting Diodes (LEDs) 400 positioned to illuminate the entire body 210 disposed on a LED panel 410, and an LED switch 420 mechanism integrated with the quick release clip 230 wherein the bump or bulb 231 of the clip 230 is depressible to trigger the switch 420. When the TACSTIX 200 is removed from its holding ring 500 or string (not shown), a switch is triggered by depression of the bump 231 by action of the ring 500 pull out, turning on the LEDs 400. When the TACSTIX is reattached to its holder, the bulb 231 is depressed again by action of the ring 500 and the switch 420 is deactivated by the trigger 231, turning off the LEDs 400. This light up feature enhances the realism of training scenarios, particularly in low-light conditions.

In the alternate embodiment 200, the LEDs 400 are preferably powered by electricity or other energy stored via the battery 300. Suitably, the battery has a charging port 310 disposed at the bottom of the TACSTIX 200. In one version, the port 310 is a USB 3.0 port.

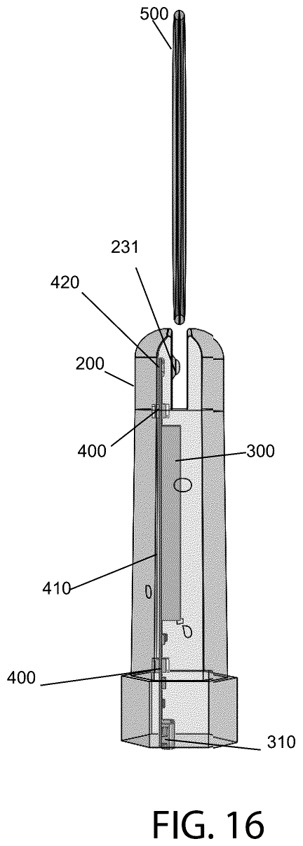

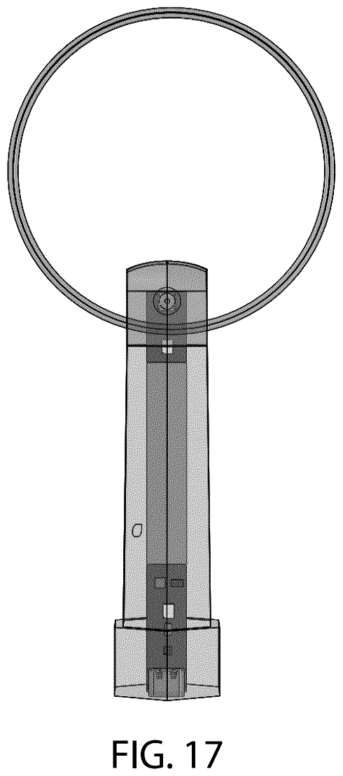

Operation of the light up feature is illustrated by FIGS. 15 through 19. FIGS. 15 and 16 show, for instance, a lit up TACSTIX 2000 with the ring 500 not coupled within the nock of the quick release clip 230. Conversely, FIGS. 17 through 19 show a unlit TACSTIX 200 with the ring coupled within the nock of the quick release clip 230. Moving from the configuration of FIGS. 15 and 16 to the configuration of FIGS. 17 through 19 involves penetration of the nock of the quick release clip 231 by the ring 500 which suitably depressed the trigger bulb 231 and switched 420 off the light. In reverse, moving from the configuration of FIGS. 17 through 19 to the configuration of FIGS. 15 and 16 involves pull out from the nock of the quick release clip 231 of the ring 500 which suitably depressed the trigger bulb 231 and switched 420 on the light.

The dimensions of the TACSTIX 100/200 are designed to closely match those of standard ChemLights. In one embodiment, the TACSTIX may have a length of approximately 6 inches (15.24 cm) and a width across the hexagonal face of approximately 0.75 inches (1.91 cm). However, these dimensions may be adjusted to match different types of ChemLights or to meet specific training requirements.

The TACSTIX 100 may be produced in various colors to simulate different tactical signals or markers. Common colors may include red, green, blue, yellow, and infrared, matching the color options available in standard ChemLights. Similarly, the TACSTIX 200 can have LEDs of various colors including red, green, blue, yellow, and infrared.

The method of using the TACSTIX 100 in training exercises closely mimics the use of actual ChemLights. For room clearing exercises, trainees can carry multiple TACSTIX units attached to their gear using the quick release clip 130. As rooms are cleared, a TACSTIX can be quickly detached and thrown into the room to mark it as cleared. The hexagonal shape ensures the TACSTIX remains visible and in place once thrown.

For perimeter marking drills, multiple TACSTIX units can be placed around an area to define boundaries or danger zones. The reusable nature of the TACSTIX allows for repeated setup and takedown of these perimeters without waste.

In signaling practice, different colored TACSTIX units can be used to represent various tactical signals, allowing trainees to practice communication protocols without expending actual ChemLights.

The “light up” version of the TACSTIX is particularly useful for low-light navigation training. Trainees can practice using illuminated markers in dark environments, activating and deactivating the TACSTIX as needed throughout the exercise.

The TACSTIX system also facilitates equipment management training. Trainees can practice proper handling, attachment, and deployment of tactical markers without the pressure of wasting resources. This allows for more frequent and thorough training in gear management.

The manufacturing process for the TACSTIX 100 may involve injection molding of the plastic body 110, with the quick release clip 130 either molded as part of the body or attached separately. For the “light up” version, additional steps would include the installation of the battery compartment, LEDs, and switch mechanism.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus, the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. A tactical training device comprising:
a body having a hexagonal cross-section and a length substantially similar to a disposable chemical light stick;
a quick release clip attached to one end of the body; and
wherein the body is constructed of a durable material for repeated use in training exercises.

2. The device of claim 1, wherein the quick release clip is configured to attach to and detach from a carrying cord.

3. The device of claim 2, wherein the body has a width of approximately 0.75 inches across the hexagonal face.

4. The device of claim 3, wherein the body has a length of approximately 6 inches.

5. The device of claim 4, further comprising printed information on at least one side of the hexagonal body.

6. The device of claim 5, wherein the body is color-coded to simulate different tactical signals.

7. The device of claim 5, further comprising:
a battery compartment within the body;
at least one LED connected to the battery compartment; and
a trigger mechanism in the quick release clip configured to activate the LED when the device is removed from a carrying cord.

8. The device of claim 7, wherein the trigger mechanism is further configured to deactivate the LED when the device is reattached to the carrying cord.

9. The device of claim 8, wherein the durable material is a transparent or translucent plastic.

10. A method of tactical training comprising:
providing a plurality of tactical training devices, each device having a hexagonal cross-section, a length substantially similar to a disposable chemical light stick, and a quick release clip;
attaching the tactical training devices to carrying cords on trainees' equipment;
instructing trainees to deploy the tactical training devices during a simulated operation; and
retrieving and reusing the tactical training devices for subsequent training exercises.

11. The method of claim 10, further comprising instructing trainees to use the tactical training devices for room clearing exercises.

12. The method of claim 10, further comprising instructing trainees to use the tactical training devices for perimeter marking drills.

13. The method of claim 10, further comprising instructing trainees to use the tactical training devices for signaling practice.

14. The method of claim 10, further comprising instructing trainees to use the tactical training devices for low-light navigation training.

15. The method of claim 10, wherein the tactical training devices include LEDs, and the method further comprises activating the LEDs when the devices are removed from the carrying cords.

16. A method of constructing a tactical training device, the method comprising:
forming a body with a hexagonal cross-section and a length substantially similar to a disposable chemical light stick;
attaching a quick release clip to one end of the body; and
constructing the body from a durable material suitable for repeated use in training exercises.

17. The method of claim 16, further comprising printing information on at least one side of the hexagonal body.

18. The method of claim 17, further comprising color-coding the body to simulate different tactical signals.

19. The method of claim 17, further comprising:
creating a battery compartment within the body;
installing at least one LED connected to the battery compartment; and
incorporating a trigger mechanism in the quick release clip configured to activate the LED when the device is removed from a carrying cord.

20. The method of claim 19, further comprising configuring the trigger mechanism to deactivate the LED when the device is reattached to the carrying cord.
